(19) United States
(12) Patent Application Publication
(10) Pub. No.: US 2009/0006317 A1
(43) Pub. Date: Jan. 1, 2009

(54) PROCESSING OF MULTIPLE DATA FILES WITH TIME-CORRELATED DATA

(76) Inventors: Robert N. Roth, Olympia, WA (US); Keith Drescher, Olympia, WA (US); Ramamurthy V. Dharmala, Beaverton, OR (US); Richard Glass, Olympia, WA (US); Saji Varkey, Redmond, WA (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/771,962

(22) Filed: Jun. 29, 2007

(51) Int. Cl. G06F 7/06

(52) U.S. Cl. 707/2; 707/E17.104

(57) ABSTRACT

A distributed search architecture utilizing multiple processing cores to search multiple files containing time-correlated and logically/semantically interdependent sequential data. A supervisory processing core may provide coordination of the search where multiple slave processing cores each search one or more data files containing time-correlated and logically/semantically interdependent sequential data. Results of the searches performed by the slave processing cores may be provided to the supervisory processing core for consolidation, further analysis and/or presentation.

### TECHNICAL FIELD

Embodiments of the invention relate to data processing. More particularly, embodiments of the invention relate to techniques for efficiently analyzing multiple data files that contain time-correlated and logically/semantically interdependent sequential data.

### BACKGROUND

When large amounts of time-correlated and logically/semantically interdependent sequential data from multiple sources must be analyzed, vast amounts of data must be analyzed and compared. Current techniques typically require extensive analysis that can result be resource intensive and result in a costly product development cycle.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of a system having multiple point-to-point links for which signal trace data may be gathered.

FIG. 2 is a block diagram of one embodiment of a system having multiple processing cores and multiple storage devices that may be utilized to analyze time-correlated and logically/semantically interdependent sequential data.

FIG. 3 is a flow diagram of one embodiment of a technique for utilizing multiple processing cores to analyze time-correlated and logically/semantically interdependent sequential data files.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

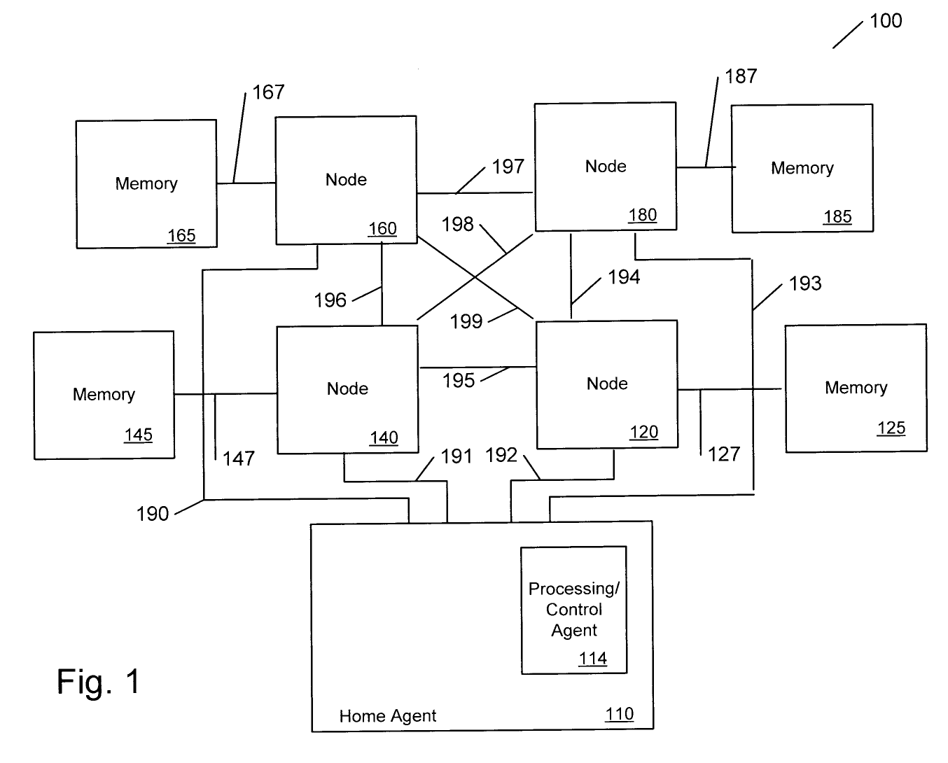

FIG. 1 is a block diagram of one embodiment of a system having multiple point-to-point links for which signal trace data may be gathered. The example of FIG. 1 includes four nodes and a home agent. However, any number of nodes may be coupled with a home agent. In one embodiment, one or more of the nodes may have a memory system that may include any type of non-cache memory, for example, dynamic random access memory (DRAM), static random access memory (SRAM), etc.

The four nodes (220, 240, 260 and 280) may be any type of system component having a cache memory, for example, a processor. In one embodiment, the nodes and home agent may be interconnected via multiple point-to-point links (290, 291, 292, 293, 294, 295, 296, 297, 298, and 299) as described with respect to FIG. 1.

In one embodiment, node controller 110 may include processing/control agent 114. Processing/control agent 114 may provide all or a portion of the functionality provided by node controller 110. Processing/control agent 114 may be implemented as hardware, software, firmware, or any combination thereof. Node controller 110 may also include additional circuits and functionality. In one embodiment, node controller 110 may be a gateway for communication beyond the cluster. Node controller 110 may also operate as a proxy home or caching agent for the home agents of remote clusters, if any. Node controller 110 may also serve as a proxy for the caching agents in the local cluster.

In order to design, debug, and/or validate a system such as the system of FIG. 1, trace data must be captured for each end of each point-to-point link. The information captured in the multiple, simultaneously captured traces will be interdependent as transactions course through the system, changing formats and protocols as they are bridged by link operators between different bus/link types, resulting in responses, and carrying useful payload information that is consumed by the various system agents. Various techniques exist to capture the trace data; however, current techniques for analyzing the trace data for semantic content and cross links transactions fragments is extremely time consuming. Described herein are techniques to search large sets of such interdependent signals trace data. The techniques used for trace data are equally applicable to any sets of parallel data that may have matches in time, as well as in logical, and/or semantic content.

As used herein a processing core refers to the processing portion of a processor chip minus cache memory/memories. That is, the processing core includes a control unit and an arithmetic logic unit (ALU) as well as any necessary supporting circuitry. Multiple processing cores may be housed within a single integrated circuit (IC) package. Various configurations of processing cores are known in the art.

In general, on processing core may manage cross-reference analysis. This core may be referred to as the Cross Reference Core Processor (CRCP). The CRCP may manage analysis performed by other processor cores. In one embodiment, the CRCP may allow time-correlated data to be streamed to multiple other processing cores at a rate limited only by storage device bandwidth so that the data may be processed in parallel with management by the CRCP.

Currently, there is no solution for optimizing the use of multi-core platforms to analyze time-correlated and logically/semantically interdependent sequential traces data. The current assumption is that conventional database searches and/or use of tools such as “grep” can be used. While this may work for searches of individual files, when the total match requires combination from multiple large files (e.g., over 3 Gb), projected processing times can be on or order of several hours for an end-to-end search over the entire file set. The techniques described herein may greatly reduce the time require to perform searches on trace data.

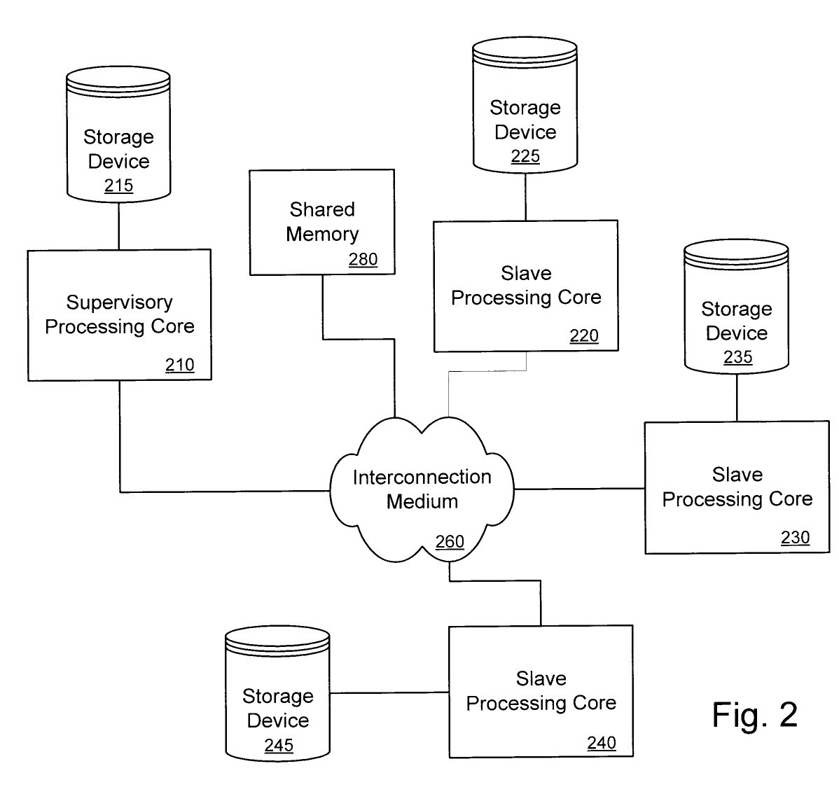

FIG. 2 is a block diagram of one embodiment of a system having multiple processing cores and multiple storage devices that may be utilized to analyze time-correlated and logically/semantically interdependent sequential data. The system of FIG. 2 may be any type of system that includes multiple processing cores and, in one embodiment, at least one storage device for each processing core. The processing cores may be within a single computational system or the processing cores may correspond to multiple, interconnected computational systems.

The multiple processing cores may communicate utilizing interconnection medium 260. Interconnection medium 260 may be any type of transmission medium that allows the multiple processor cores to communicate with each other. For example, interconnection medium 260 may be a network to interconnect multiple computational systems each having one or more processing cores and/or one or more storage devices.

The time-correlated and logically/semantically interdependent sequential data to be processed may be gathered in any manner known in the art. The time-correlated and logically/semantically interdependent sequential data may be stored such that each storage device (e.g., 225, 235, 245) coupled to a slave processing core (e.g., 220, 230, 240) has a data file corresponding to a separate data source. For example, when analyzing trace data from a system having multiple point-to-point links, each storage device may store trace data corresponding to one point-to-point link. As another example, each storage device may store seismic data corresponding to a specified location.

Supervisory processing core 210 may communicate with slave processing cores 220, 230 and 240 in order to cause slave processing cores to analyze the time-correlated and logically/semantically interdependent sequential data stored on storage devices 225, 235 and 245, respectively. Any type of data analysis may be performed utilizing the architecture of FIG. 2. For example, supervisory processing core 210 may provide one or more data strings (e.g., retrieved from storage device 215) to each of slave processing cores 220, 230 and 240. Supervisory processing core 210 may also provide any additional information/parameters that may be utilized to perform the search.

In response to receiving the search parameters from supervisory processing core 210, each of slave processing cores 220, 230 and 240 may independently begin analysis of the time-correlated and logically/semantically interdependent sequential data stored on storage devices 225, 235 and 245, respectively. By utilizing a processing core for each data stream, processing of the time-correlated and logically/semantically interdependent sequential data may be accomplished in parallel. In one embodiment, slave processing cores 220, 230 and 240 may have access to, and store analysis information in, shared memory 280.

In one embodiment, when one of the slave processing cores identifies a match, the slave processing core may write information related to the identified match to shared memory 280. The information may include, for example, the time designation corresponding to the match identified in the time-correlated and logically/semantically interdependent sequential data file, conditions associated with the match, including decoded logical and semantic characteristics, and/or any additional information. This additional information may be useful if, for example, the source of an identified error is remote in time from the match or the error condition. It can also be useful for higher level semantic and logical pattern recognition over individual and/or combined sets of traces.

In one embodiment, a multi-stage searching process may be utilized within the architecture of FIG. 2. As described above, search parameters may be distributed by, for example, supervisory processing core 210 to slave processing cores 220, 230 and 240. The slave processing cores may perform a primitive search that returns potential for a complete match. For example, the slave processing cores may be directed to search for a portion of the data or pattern sought through a complete analysis. The primitive search may be directed to a first byte or other minimum recognizable size quantum of information that would be found as a possible match point for a higher level, more complete match.

Upon finding a primitive match, a slave processor may generate pointers to the found point in the trace, along with additional information about the found quantum of (i.e. “crumbs”) of information related to the primitive match. These crumbs may be used in further analysis to achieve a complete search. For example, a crumb may include timing and/or link or device state information, or decoded logical/semantic decode relative to link traffic stream corresponding to each primitive match. Any relevant information may be included in a crumb associated with the primitive match. In one embodiment, the slave processing core(s) may place primitive match information and/or any associated crumbs in a shared memory accessible by the supervisory processing core. In an alternate embodiment, the slave processing core(s) may send the primitive match information and/or the any associated crumbs to the supervisory processing core.

The supervisory processing core may analyze the results of the primitive matches and/or any associated crumbs. The supervisory processing core may, for example, refine search parameters based on the information from the slave processing cores. In one embodiment, the supervisory processing core may perform a first level of analysis on the information from the slave processing cores. Upon completion of the first level of analysis, the supervisory processing core may determine whether further analysis at each primitive search found location/crumbs by the supervisory processing core is beneficial.

The supervisory processing core may provide results of the local analysis to a user via a graphical user interface or other input/output mechanism. The supervisory processing core may also provide the results of the local analysis to an application running on the supervisory processing core or other processing core that may take further action, including higher levels of analysis, statistics accumulation, or any other useful higher level operations. Alternatively, the supervisory processing core may cause one or more of the slave processing cores to perform further searching and/or other analysis on the time-correlated and logically/semantically interdependent sequential data files. By utilizing multiple processing cores for multiple data sets, the overall data analysis may be achieved in a more efficient manner than by using traditional techniques.

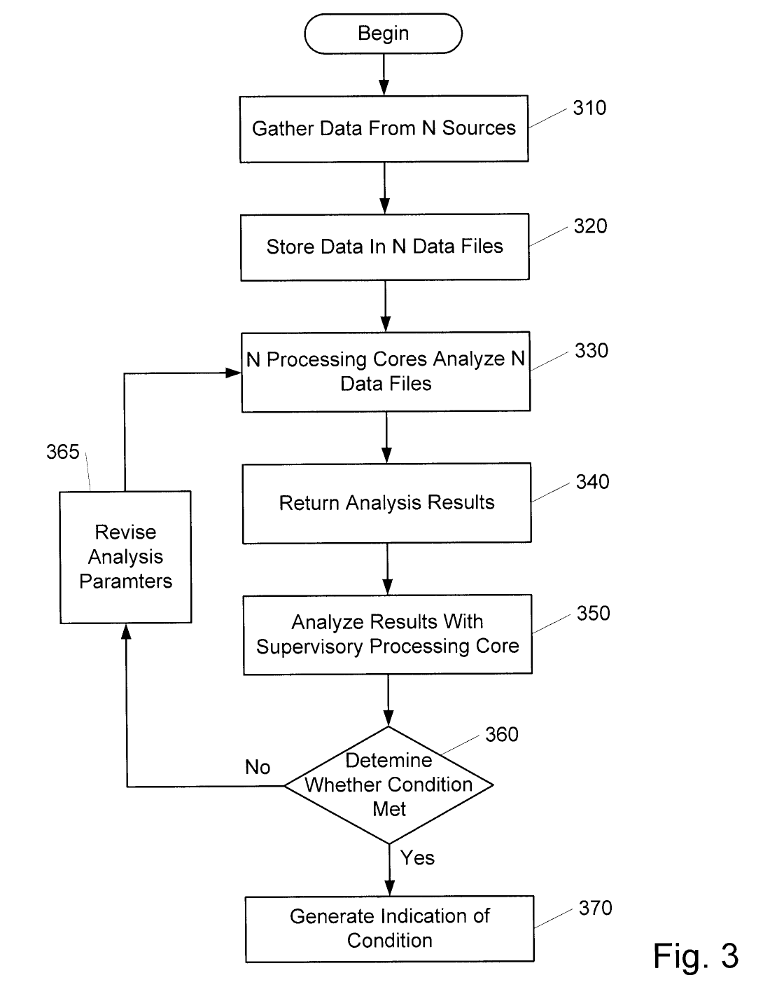

FIG. 3 is a flow diagram of one embodiment of a technique for utilizing multiple processing cores to analyze time-correlated and logically/semantically interdependent sequential data files. The technique of FIG. 3 may be applied to any number of processing cores. In one embodiment, N+1 processing cores are utilized, where N represents the number of time-correlated and logically/semantically interdependent sequential data files to be analyzed. As discussed above, the time-correlated data and logically/semantically interdependent sequential files may correspond to various types of data streams captured across different bus/link types, and therefore with different protocols/semantics, but still interdependent and related for system operation.

The time-correlated and logically/semantically interdependent sequential data to be analyzed is acquired from N sources, 310. The time-correlated and logically/semantically interdependent sequential data may be gathered in any manner known in the art. For example, multiple data acquisition mechanisms may be configured to acquire time-correlated and logically/semantically interdependent sequential data for multiple reference points. The data may be organized as a separate file for each reference point. In one embodiment, each file may be stored on a storage device, 320, for example, a hard drive associated with separate processing cores as illustrated in FIG. 2.

A primitive search of the time-correlated and logically/semantically interdependent sequential data may be initiated. In one embodiment, a supervisory processing core may cause the multiple slave processing cores to search the respective time-correlated data and logically/semantically interdependent sequential files based on search parameters provided by the supervisory processing core. The search parameters may include, for example, a value or values to be identified in the respective time-correlated and logically/semantically interdependent sequential data files. Other search parameters may also be supported, for example, a portion of a value to be identified and/or timing, logical, or semantic pattern considerations associated with the value or values to be identified.

The N slave processing cores may then perform the primitive search, 330. As described above, the slave processing cores may each process a data file corresponding to data acquired from a reference point. In an alternate embodiment, a slave processing core may process two (or more) data files corresponding to data acquired from two (or more) reference points. This alternate embodiment may, however, result in decreased performance as compared to an embodiment in which each processing core searches a single data file.

In one embodiment, when providing search results, the slave processing cores may provide information in addition to whether a match has been identified. This additional information may be referred to as “crumbs,” which may be used in further processing. For example, a slave processor may provide timing information with search results that provide an indication of a time at which the match was identified or local logical or semantic context for the matched quantum in the traffic stream. Crumbs may be used for any purpose. As another example, a crumb may be provided that includes an indication of the cause of the match. This may be useful when the match is to be used for debugging or other fault-based purposes.

The primitive search results and/or the crumbs may be returned, 340. Returning of the primitive search results and/or the crumbs may be accomplished by each slave processing core writing the respective search results and/or crumbs to a shared memory accessible by the supervisory processing core. Alternatively, the slave processing cores may send the search results and/or crumbs directly to the supervisory processing core.

The supervisory processing core may analyze the primitive search results and/or crumbs, 350. The analysis performed by the supervisory processing core may vary depending on, for example, the search to be performed, the results and/or crumbs returned, or other factors. If, for example, the primitive search is directed to a portion of the data to be identified, the supervisory processing core may evaluate the results and determine whether further searching should be performed by one or more of the slave processing cores.

If a predetermined condition is met and no further analysis is desired, 360, the supervisory processing core may generate an indication of the condition by, for example, returning the consolidated search results, 370. The search results may be returned, for example, by providing the consolidated search results to an application executed by the supervisory processing core. The results may be displayed to a user or otherwise stored and/or presented in a usable format. The results may be transmitted to a remote device, for example,

If further analysis is desired, 360, the search parameters may be revised, 365, by the supervisory processing core and transmitted to the slave processing cores for further searching. This process may be repeated as necessary until a satisfactory search result is achieved.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
one or more storage devices to store N data files;
N processing cores each coupled with at least one of the one or more storage devices, the N processing cores each to analyze one of the N data files;
a shared memory region accessible by the N processing cores to store results from the analysis of the N processing cores;
a supervisory processing core coupled with the shared memory to access the results and to determine whether one or more of the results corresponds to a preselected condition.

2. The apparatus of claim 1 wherein the N data files comprise N signal trace data files.

3. The apparatus of claim 2 wherein each of the N trace data signals corresponds to a point-to-point link within a multi-node system.

4. The apparatus of claim 1 wherein the N data files comprise N seismic data files.

5. The apparatus of claim 1 wherein the one or more storage devices comprise N storage devices each coupled with at least one of the N processing cores.

6. The apparatus of claim 5 wherein the N storage devices comprise N hard disk drives.

7. A system comprising:
one or more storage devices to store N data files;
N processing cores each coupled with at least one of the one or more storage devices, the N processing cores each to analyze one of the N data files;
a shared dynamic random access memory (DRAM) coupled to the N processing cores to store results from the analysis of the N processing cores;
a supervisory processing core coupled with the shared DRAM to access the results and to determine whether one or more of the results corresponds to a preselected condition.

8. The system of claim 7 wherein the N data files comprise N signal trace data files.

9. The system of claim 8 wherein each of the N trace data signals corresponds to a point-to-point link within a multi-node system.

10. The system of claim 7 wherein the N data files comprise N seismic data files.

11. The system of claim 7 wherein the one or more storage devices comprise N storage devices each coupled with at least one of the N processing cores.

12. The system of claim 11 wherein the N storage devices comprise N hard disk drives.

13. A method comprising:
initiating, with a supervisory processing core, a search of N data files each including time-correlated and logically/semantically interdependent sequential data, wherein the search of the N data files is performed by N slave processing cores;
searching the N data files of time-correlated and logically/semantically interdependent sequential data with the N slave processing cores, wherein each of the N slave processing cores searches one of the N data files;
analyzing results returned by the N slave processing cores with the supervisory processing core; and
storing the analyzed results in a memory device coupled with the supervisory processing core.

14. The method of claim 13 wherein the N data files comprise N signal trace data files.

15. The method of claim 14 wherein each of the N trace data signals corresponds to a point-to-point link within a multi-node system.

16. The method of claim 13 wherein the N data files comprise N seismic data files.

17. The method of claim 13 wherein the results returned by the N slave processing cores comprise at least one indication associated with at least one of N results having information corresponding to the result.

18. An article comprising a computer-readable storage medium having stored thereon instructions that, when executed, cause a plurality of processing cores to:
initiate, with a supervisory processing core, a search of N data files each including time-correlated and logically/semantically interdependent sequential data, wherein the search of the N data files is performed by N slave processing cores;
search the N data files of time-correlated and logically/semantically interdependent sequential data with the N slave processing cores, wherein each of the N slave processing cores searches one of the N data files;
analyze results returned by the N slave processing cores with the supervisory processing core; and
store the analyzed results in a memory device coupled with the supervisory processing core.

19. The article of claim 18 wherein the N data files comprise N signal trace data files.

20. The article of claim 19 wherein each of the N trace data signals corresponds to a point-to-point link within a multi-node system.

21. The article of claim 18 wherein the N data files comprise N seismic data files.

22. The article of claim 18 wherein the results returned by the N slave processing cores comprise at least one indication associated with at least one of N results having information corresponding to the result.
